(19) United States
(12) Patent Application Publication
(10) Pub. No.: US 2011/0083105 A1
(43) Pub. Date: Apr. 7, 2011

(54) LIST-EDITING METHOD AND MOBILE DEVICE ADAPTED THERETO

(75) Inventors: Seung Woo SHIN, Seoul (KR); Seung Wook NAM, Bucheon-si (KR); Hyun Kyung SHIN, Seoul (KR)

(73) Assignee: SAMSUNG ELECTRONICS CO. LTD., Suwon-si (KR)

(21) Appl. No.: 12/884,353

(22) Filed: Sep. 17, 2010

(30) Foreign Application Priority Data
Oct. 6, 2009 (KR) 10-2009-0094684

(51) Int. Cl. G06F 3/048

(52) U.S. Cl. 715/830

(57) ABSTRACT

A list-editing method and a mobile device adapted to the method are provided. The method includes displaying a plurality of items on a screen, selecting at least one of the plurality of items according to an input signal, fixing at least one selected item at one side of the screen, and moving at least one non-selected item on the screen, according to a scroll signal.

### PRIORITY

This application claims the benefit under 35 U.S.C. §119(a) of a Korean patent application filed on Oct. 6, 2009 in the Korean Intellectual Property Office and assigned Serial No. 10-2009-0094684, the entire disclosure of which is hereby incorporated by reference.

### BACKGROUND OF THE INVENTION

1. Field of the Invention

The present invention relates to mobile communication systems. More particularly, the present invention relates to a list-editing method that can easily change the order of items in a list and to a mobile device adapted to the method.

2. Description of the Related Art

Mobile devices are widely used because of easy portability and can provide a variety of functions. The mobile devices have a variety of input modes to provide user functions.

Electronic parts to be installed in the mobile devices have been manufactured small so that the size of the mobile devices can be compact. More particularly, the input unit of the mobile devices has been manufactured small. In order to overcome the size limitation of the input unit, conventional mobile devices have employed a touch screen including a display panel and a touch panel. Although the mobile devices are equipped with a touch screen, the mobile devices cannot quickly detect a user's touch gesture and respond promptly thereto. Therefore, the mobile devices cannot smoothly provide a variety of user functions.

Therefore, a need exists for a mobile device and method for responding promptly to a user's touch gesture and for easily utilizing user functions in a limited input environment.

### SUMMARY OF THE INVENTION

An aspect of the present invention is to address at least the above mentioned problems and/or disadvantages and to provide at least the advantages described below. Accordingly, an aspect of the present invention is to provide a list-editing method that can easily change the order of items in a list and a mobile device adapted to the method.

In accordance with an aspect of the present invention, a method for list-editing is provided. The method includes displaying plurality of items in a list on a screen, selecting at least one of the plurality of items according to an input signal, fixing at least one selected item at one side of the screen, and moving at least one non-selected item on the screen, according to a scroll signal.

In accordance with another aspect of the present invention, a mobile device for supporting list-edit is provided. The device includes a display panel for displaying a plurality of items in a list, an input unit or a touch screen for creating an input signal for selecting at least one of the plurality of items in the list and a scroll signal for moving at least one non-selected item on the display panel, and a controller for fixing at least one selected item at one side of a screen, for moving at least one non-selected item on the screen according to a scroll signal, and for altering the order of at least one non-selected item in the list.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart describing a list-editing method of a mobile device according to an exemplary embodiment of the present invention;

FIG. 2 is a view illustrating a screen of a mobile device illustrating a list according to an exemplary embodiment of the present invention;

FIG. 3 is a view illustrating screens describing a list-editing method according to an exemplary embodiment of the present invention;

FIG. 4 is a view illustrating screens describing a list-editing method according to an exemplary embodiment of the present invention;

FIG. 5 is a view illustrating screens describing a list-editing method according to an exemplary embodiment of the present invention;

FIG. 6 is a view illustrating screens describing a list-editing method according to an exemplary embodiment of the present invention; and

FIG. 7 is a schematic block diagram illustrating a mobile device supporting a list-editing function according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms or words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

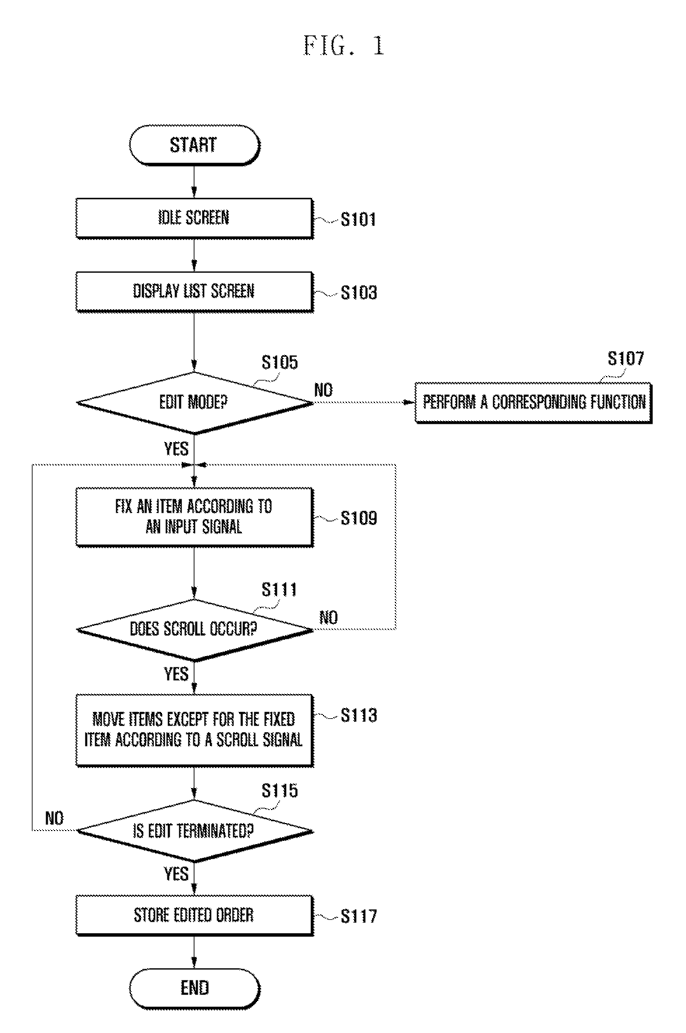

FIG. 1 is a flowchart describing a list-editing method of a mobile device, according to an exemplary embodiment of the present invention.

Referring to FIG. 1, when the mobile device is turned on, the mobile device initializes its elements and then displays a default idle screen on the display panel in step S101. The mobile device may also be set in such a way to display an idle screen on the display panel when the mobile device is woken from a sleep mode. When the display panel is activated, the mobile device may be set, according to a user's settings, in such a way to activate a touch panel to detect a user's touch. Although exemplary embodiments of the present invention will be described below based on a mobile device with a touch screen including a touch panel and based on a control method and apparatus using touch events created via the touch screen, it should be understood that the present invention is not limited thereto. For example, the touch events generated by the touch screen may be replaced with confirmation input signals, direction input signals, and the like, generated by directional keys or a confirmation key of an input unit, where the input unit is mechanically installed to the mobile device.

Thereafter, the mobile device displays a list screen, corresponding to a user function selected by a user, on the display panel in step S103. The list screen contains at least one item, for example, a menu screen, a music file list screen, an image file screen, a phone book screen, a multi-image list screen, and the like. Although a method for changing the order of items will be described based on a list screen displaying a list of multi rows and one column items, it should be understood that the present invention may also be applied to a list with one row by multi columns items, a list with a grid form or multi rows by multi column items.

The mobile device determines whether a command signal for executing an edit mode is input in step S105. As a result, the mobile device provides a key map or a button for executing the edit mode. The user operates a key map displayed at one side of the list screen or a hot-key allocated to the input unit in order to switch a current screen to the edit screen, thereby editing a list screen containing at least one item. If the mobile device receives a user's input signal for executing an edit mode, the mobile device determines whether an edit mode is executed.

If the mobile device determines that another input signal, instead of a command for executing an edit mode, is input in step S105, the mobile device performs a user function corresponding to another input signal in step S107. For example, if the mobile device receives an input signal for activating a particular item on a music file list screen, the mobile device activates the particular item and outputs an audio signal.

On the contrary, if the mobile device determines that a command for executing an edit mode has been input in step S105, the mobile device fixes an item according to the command in step S109. That is, if the user inputs a first input signal for selecting a particular item to the mobile device, in order to change the order of the particular item in the list, the mobile device fixes the particular item to a specific location on the display panel. For example, the first input signal may be a tap touch event and an input signal corresponding to a confirmation key. The specific location may be a location where a selected item is displayed on the first list screen or a location where an item, selected according to a second input signal, for example, a scroll signal, is moved to a certain distance on the list screen.

After fixing an item in step S109, the mobile device determines whether a second input signal, for example, a scroll signal, occurs in step S111. The scroll signal may be a touch event where the mobile device user touches one side of the touch screen with his/her finger and then moves the finger thereon in a certain direction at a certain speed, without having a long contact with the touch screen. In addition, the scroll signal may also be an input signal for moving a cursor, displayed on a list screen, or a highlight for indicating a particular item in a certain direction, using directional keys of the input unit. The scroll operation includes a flick gesture where an object touch, for example the finger, and the like, is moved in a certain direction at a certain acceleration without losing contact with the touch screen.

If the mobile device determines that a second input signal, for example a scroll signal, has not occurred in step S111, the mobile device returns to step S109. On the contrary, if the mobile device determines that a second input signal, for example a scroll signal, has occurred in step S111, the mobile devices moves the remaining items, except for the fixed item in step S109, in a certain direction according to the scroll signal in step S113. The area displaying the moved items may be displayed in such a way that it is or is not superimposed with the area displaying the fixed item. If the area displaying the moved items may be displayed in such a way that the area is superimposed with the area displaying the fixed item, the fixed item may be displayed translucently or transparently.

After moving the remaining items in step S113, the mobile device determines whether a command for terminating an edit mode is input in step S115. If the mobile device determines that a command for terminating an edit mode has not been input in step S115, the mobile device returns to step S109. On the contrary, if the mobile device determines that a command for terminating an edit mode has been input in step S115, the mobile device stores the information regarding the order of items, altered according to the scroll signal, in the storage unit in step S117.

As described above, the list-editing method may easily change the order of a particular item, by fixing the location of the particular item and changing the locations of the remaining items except for the particular item. This allows the user to easily recognize the location relationship between the particular item and others.

Screen interfaces displayed on the display panel of the mobile device will be described below.

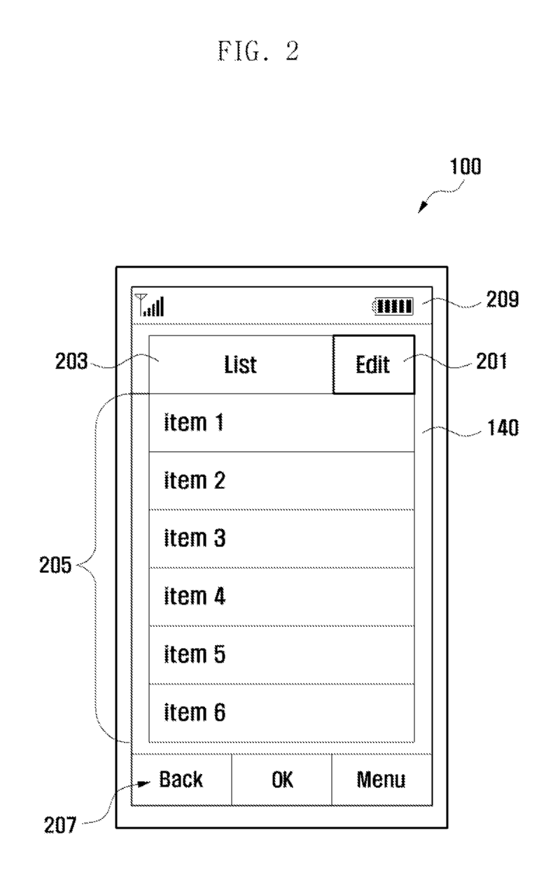

FIG. 2 is a view illustrating a screen of a mobile device illustrating a list according to an exemplary embodiment of the present invention.

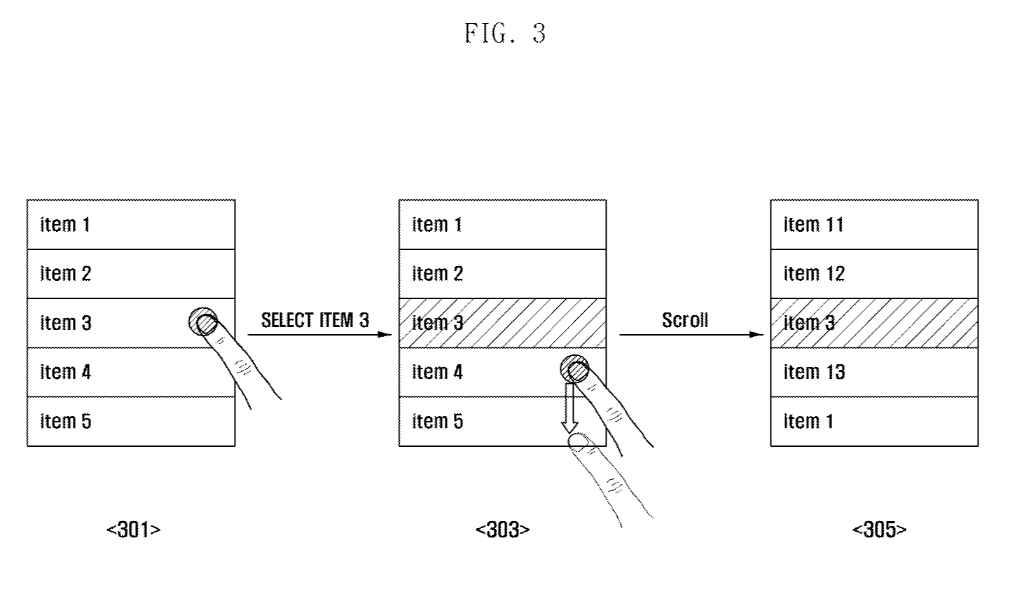

Referring to FIG. 2, the mobile device 100 displays at least one or more items (Item 1, Item 2, . . . , Item 6) in a list on its screen 140, when a user operates the touch screen 140 or an input unit. The mobile device 100 also displays an indicator of received signal strength in mobile communication and an indicator for showing remaining battery amount on the indicator region 209. The list screen is comprised of a title region 203 for displaying the text “List”, an item region 205 for displaying at least one item, and a key region 207 for displaying a map of keys that may activate at least one of a previous screen, an item, and a menu. The list screen also contains an edit key region 201 for executing an edit mode to edit the order of items in a list. When the user touches the edit key region 201 on the touch panel, the mobile device 100 detects the user's touch and allows the user to operate an edit mode. A description regarding the change in the order of items is described in more detail with reference to FIG. 3.

FIG. 3 is a view illustrating screens describing a list-editing method according to an exemplary embodiment of the present invention.

Referring to FIGS. 2 and 3, the mobile device 100 displays items in a list, for example, Items 1, 2, 3, 4 and 5, on screen 301, according to a user's selected menu or function. The five items, Items 1 to 5, correspond to various types of user functions provided by the mobile device 100. Examples of the various types of user functions are a variety of contents and files, such as audio files, image files, photograph files, menu items, user information items recorded in a phone book, items contained in schedule information, items downloaded from a server via a web browser, and the like. The mobile device user may select a particular one of the items in a list and change the order of the selected items therein, in an edit mode. Selecting one of the items in a list may be performed by directional keys or a confirmation key of the input unit or by a touch event created when a touch gesture is applied to the item to be selected on the touch screen 140. If the mobile device 100 is equipped with a touch screen 140, the user may select or touch an item and change its order in the list, for example, Item 3, on screen 301, with his/her finger. An option for the touch screen 140 may be set by the mobile device manufacturer or a user's personal settings. For example, if the user taps an item display region once or twice, the mobile device 100 determines that the item has been selected.

In order to change the order of Item 3 in the list, the mobile device user creates a scroll event on screen 303 with his/her finger. That is, the mobile device user touches a region displaying Item 4 and moves his/her finger to the region displaying Item 5, without losing contact on the screen, thereby creating a scroll down event. It should be understood that the present invention is not limited thereto. For example, when the mobile device user touches a region displaying Item 1 and moves his/her finger to the region displaying Item 5, without losing contact on the touch screen 140, the mobile device 100 may also create a scroll down event. In addition, when the mobile device user touches a region displaying Item 3 and moves his/her finger to the region displaying Item 5, without losing contact on the touch screen 140, the mobile device 100 may also create a scroll down event. Therefore, if the user selects an item, for example, Item 3, and performs a gesture for creating a scroll event in a particular direction on the touch screen 140, the mobile device 100 may detect the gesture and create a corresponding scroll event.

When the scroll event has occurred on the screen 303, the mobile device 100 fixes Item 3 on the screen 305, and moves the remaining items, except for Item 3, in the direction to create a scroll event. If the currently displayed list has 13 items and the mobile device 100 detects a scroll event for scrolling a reverse order of items with respect to Item 1, the 13th item, Item 13, is displayed, succeeding to Item 1, on screen 305. That is, it is assumed herein that the mobile device 100 displays or provides the items in the list on or to the screen, in a ring structure, when a list search is performed. Therefore, the mobile device 100 may move the remaining items (Item 1, 2, 4, and 5), except for Item 3, in the direction of the user's created scroll event. Meanwhile, if Item 5 is removed from the list screen according to the scroll event, the mobile device 100 may display the 13th item, Item 13, succeeding to Item 1, and the remaining items arranged in the reverse order. If the scroll events continue occurring, the mobile device 100 removes Items 2, 4, and 5 from the screen 305 and simultaneously displays Items 13, 12, and 11 thereon. Since the location of Item 3 is fixed on the screen, Item 3 is located between Item 12 and 13.

In an exemplary implementation, the mobile device 100 may fix an item selected by the user at a location on the screen when the item is selected or at a preset one side of the screen and may move the remaining non-selected items on the screen, thereby changing the order of the selected item in the list. The mobile device 100 may perform a control operation so that the display region of the selected item is not superimposed with the display regions of other items and the display regions of the remaining items that are moving according to the scroll event. Therefore, the non-selected items skip the display region of the selected item while they are moving according to the scroll event. The mobile device 100 according to an exemplary embodiment of the present invention allows the user to fix a favorite item on the screen and to conduct a searching operation with respect to the remaining items, so that the user may change the order of the reaming items with respect to the selected item.

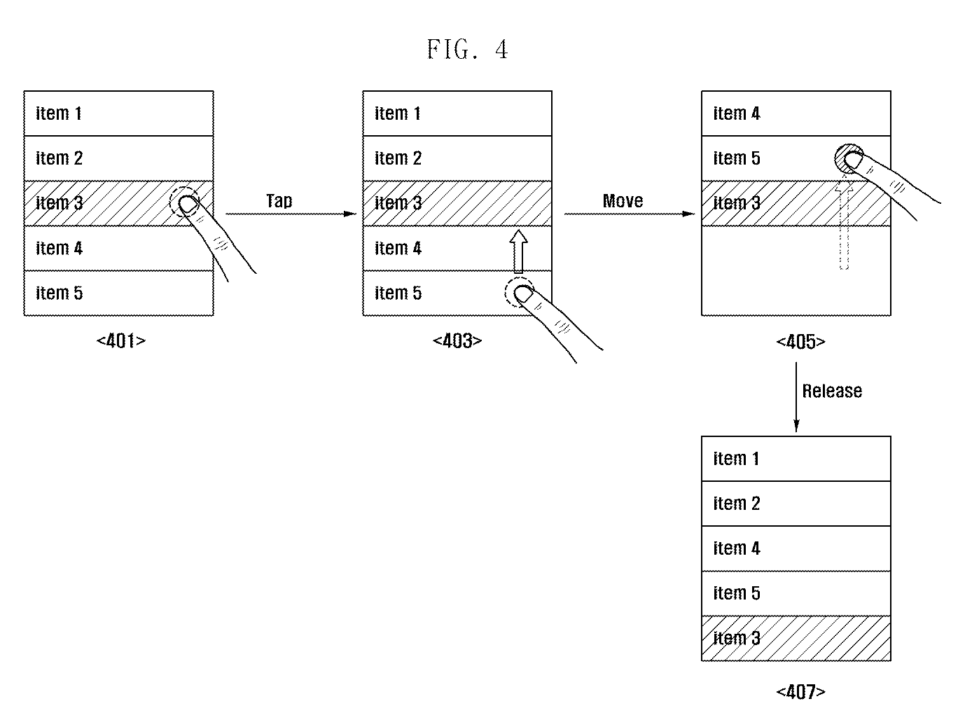

FIG. 4 is a view illustrating screens describing a list-editing method according to an exemplary embodiment of the present invention.

Referring to FIGS. 2 and 4, the mobile device 100 displays items in a list, for example, Items 1, 2, 3, 4 and 5, on screen 401, according to a user's selected menu or function. The user may select one of the items in a list by using the directional keys or the confirmation key of the input unit or by a touch event created when the user taps the display region of the item. If the mobile device 100 is equipped with a touch screen 140, the user may tap and select an item, and change its order in the list, for example, Item 3, on screen 401, with his/her finger. The option of the touch screen 140 may be set by the mobile device manufacturer or a user's personal settings.

After selecting Item 3, the user touches one side of the touch screen 140 and moves his/her touched finger thereon in a certain direction at a speed or a certain acceleration, thereby creating a scroll event. For example, if the user touches one side of Item 5 and then moves his/her touched finger on screen 403 toward the top, without losing contact on the touch screen 140, the mobile device 100 creates a scroll up event.

If Item 5 is the last item in the list of items, the remaining items except for the fixed Item 3 are moved toward the top according to the scroll event. In this case, as illustrated on screen 405, the mobile device 100 may display Item 5 adjacent to the Item 3. That is, the mobile device 100 may arrange Item 4 and Item 5 higher than the fixed Item 3 on screen 405. Thereafter, although a scroll up event occurs additionally, the mobile device 100 does not move any item.

If the user releases his/her finger from the screen, the mobile device 100 reconfigures the order of items and displays the reconfigured order of items on screen 407. The mobile device 100 may arrange Item 3 at the lowest position of the screen and then Items 5, 4, 2 and 1 toward the top from the position. Therefore, the mobile device 100 may display a list of items where the location of Item 3 is altered on screen 407, compared to screen 401.

Although an exemplary embodiment of the present invention has been described based on a list of five items, it should be understood that the present invention is not limited thereto. For example, a list of six or more items, for example, a list of eight items may be applied to exemplary embodiments of the present invention. If a scroll event continues to occur so that the eighth item, Item 8, passes by the fixed Item 3, the mobile device 100 may arrange Item 8 at an upper side of Item 3 and may fix Item 8 thereat. Although a scroll up event occurs additionally, the mobile device 100 may be designed not to move any items. Meanwhile, if the user releases his/her finger from the screen, the mobile device 100 may arrange Item 3 at the lowest position of the screen and then Item 8, 7, 6 and 5 toward the top therefrom.

As described above, a list-editing method list may allow for a change in the order of items and may allow the user to quickly recognize the changed order of items.

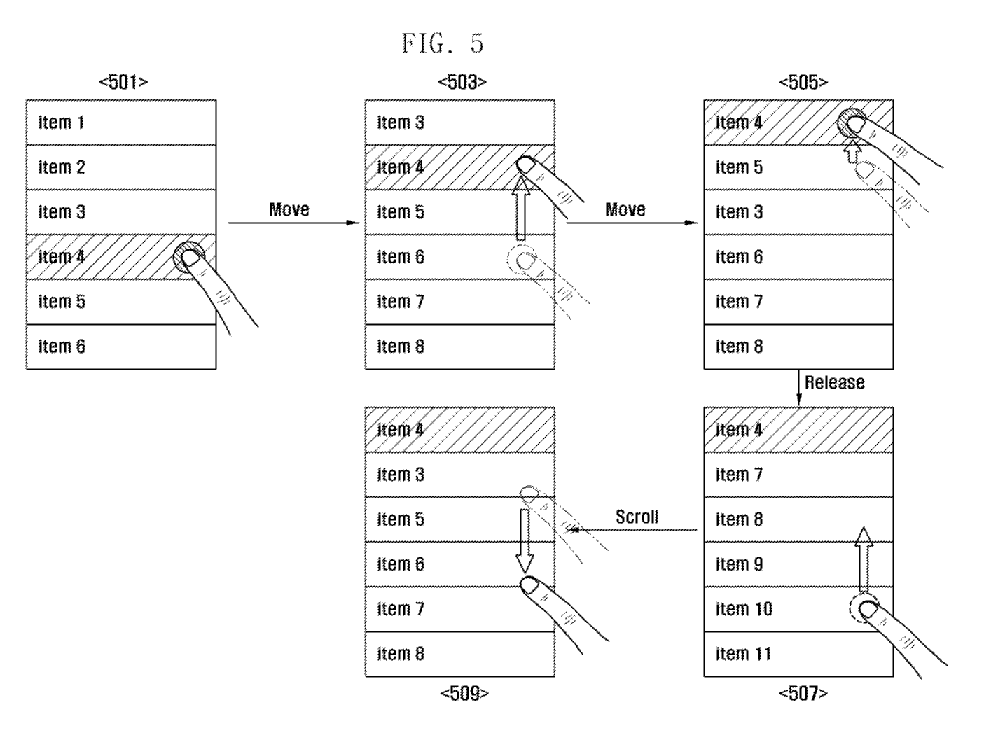

FIG. 5 is a view illustrating screens describing a list-editing method according to an exemplary embodiment of the present invention.

Referring to FIGS. 2 and 5, the mobile device 100 displays a list screen including six item regions according to a user's request. For example, the mobile device 100 may display six items, Items 1, 2, . . . , and 6 on the list screen 501. The user may select one of the items displayed on the list screen by the directional keys or the confirmation key of the input unit or by a touch event created when the user taps the display region of the item. If the mobile device 100 is equipped with a touch screen 140, the user may tap and select an item, for example, Item 4, on the list screen 501, with his/her finger. The option of the touch screen 140 may be set by the mobile device manufacturer or a user's personal settings.

After selecting the item, the user touches the touch screen 140 and moves his/her finger in a certain direction without losing contact on the touch screen 140, thereby creating a scroll event. For example, as illustrated in the list screen 503, the user touches the display region of Item 4 and moves his/her finger toward the top without losing contact on the touch screen 140, thereby creating a scroll up event. In this case, the mobile device 100 moves the items to the top of the list screen 503, according to the scroll event. That is, the mobile device 100 removes Items 1 and 2 from the list screen 503 and instead displays Items 7 and 8 below Item 6. Meanwhile, since Item 4 is moved to the top of the list screen according to the scroll event, Item 4 may be arranged at a region touched by the finger.

Thereafter, if the user further creates a scroll up event, the mobile device 100 moves and arranges Item 4 to and at the highest position of the list screen 505. In this case, the mobile device 100 removes Item 3 from the list screen 505 and instead displays Item 9 thereon so that Item 9 is arranged below Item 8. The mobile device 100 fixes Item 4 at the highest position of the list screen.

Next, the user may release his/her finger from the list screen 505 and simultaneously touch a particular region on the list screen, for example, at the bottom of one side of the list screen, thereby creating a touch down event. That is, the user may additionally create a scroll up event, on the list screen 507. In this case, the mobile device 100 moves the items to the top. Since Item 4 is fixed at the highest position of the list screen, Item 4 is not moved while the mobile device 100 is moving the items. Therefore, the mobile device 100 removes Items 5, 3 and 6 from the list screen 507 and simultaneously arranges Items 10 and 11 below Item 9, according to the scroll up event.

On the other hand, the user may create a scroll down event opposite to the scroll up event, as illustrated on the list screen 509. In this case, the mobile device 100 may display the items, which were removed from the list screen by the scroll up event, on the list screen. If the scroll down event occurs to such an extent that Item 3 may be arranged below Item 4, the mobile device 100 arranges Item 3 at the lower side of Item 4 and Item 5 below Item 3, as illustrated on the list screen 509. That is, according to an occurrence of the scroll down event, the mobile device 100 removes Items 11, 10 and 9 from the list screen 507, so that Items 7 and 8 are shifted to the bottom and arranged thereat.

Although the list-editing method, as illustrated in FIG. 5, has been described in such a way that Item 4 is fixed at the highest position of the list screen, it should be understood that the present invention is not limited thereto. For example, the exemplary embodiments of the present invention may be modified in such a way that Item 4 is fixed at the lowest position of the list screen as the user selects Item 4 and then creates a scroll down event for arranging Item 4 at the lowest.

As described above, the list-editing method fixes at least one item selected by a user at one side of the list screen, for example, the highest or lowest position, according to a scroll event, and moves non-selected items on the list screen, so that the user may easily alter the order of the selected item and may quickly conduct a search process with respect to all of the items. Meanwhile, although an exemplary embodiment of the present invention has been implemented in such a way that Item 4 is fixed at the highest position of the list screen 509 according to the scroll down event, it may be modified so that Item 4 is moved on the list screen, to the bottom, according to a scroll down event. That is, if a scroll down event occurs on the list screen 507 where Item 7 is arranged below Item 4, Item 4 may be moved to the bottom together with Items 7, 8, 9, 10 and 11. If the scroll down event continues to occur and Item 4 is located at the lowest position of the list screen, the mobile device 100 fixes Item 4 thereat so that Item 4 cannot be removed from the list screen.

In addition, although a list-editing method according to an exemplary embodiment of the present invention, as illustrated in FIG. 5, has been explained in such a way that a selected item is moved at the highest or lowest position of the list screen, according to a scroll event, and fixed thereat, it should be understood that the present invention is not limited thereto. For example, the mobile device 100 may automatically move a user's selected item to the highest or lowest position of the list screen, according to a user's settings, and fix it thereat.

If the user selects many items and moves them according to a scroll event, the mobile device 100 may fix the first of the selected items, which arrived at the highest and lowest positions of the list screen, thereat. Thereafter, another selected item is located at the position second from the highest or lowest position of the list screen, the mobile device 100 fixes the other selected item thereat, near the selected item that has been already fixed at the highest or lowest position of the list screen. That is, if many items are selected, the mobile device 100 may arrange them in such a way that the first item arrived at the highest or lowest position of the list screen is fixed thereat and the remaining items are fixed, in order, from the location of the first fixed item, according to the direction of the scroll event. If the scroll up and down events are created by a certain time difference, i.e., if the scroll up event occurs and then the scroll down event occurs after a period of time has elapsed, and if a selected item is already located at the highest or lowest position of the list screen when the scroll event is created, the mobile device 100 may fix the selected item at a corresponding location. Therefore, the mobile device 100 may fix the selected items at both of the highest and lowest positions of the list screen. In addition, when the mobile device 100 arranges many selected items from the highest position of the list screen to the bottom or from the lowest position of the list screen to the top, in order, the mobile device 100 may fix corresponding selected items at corresponding locations.

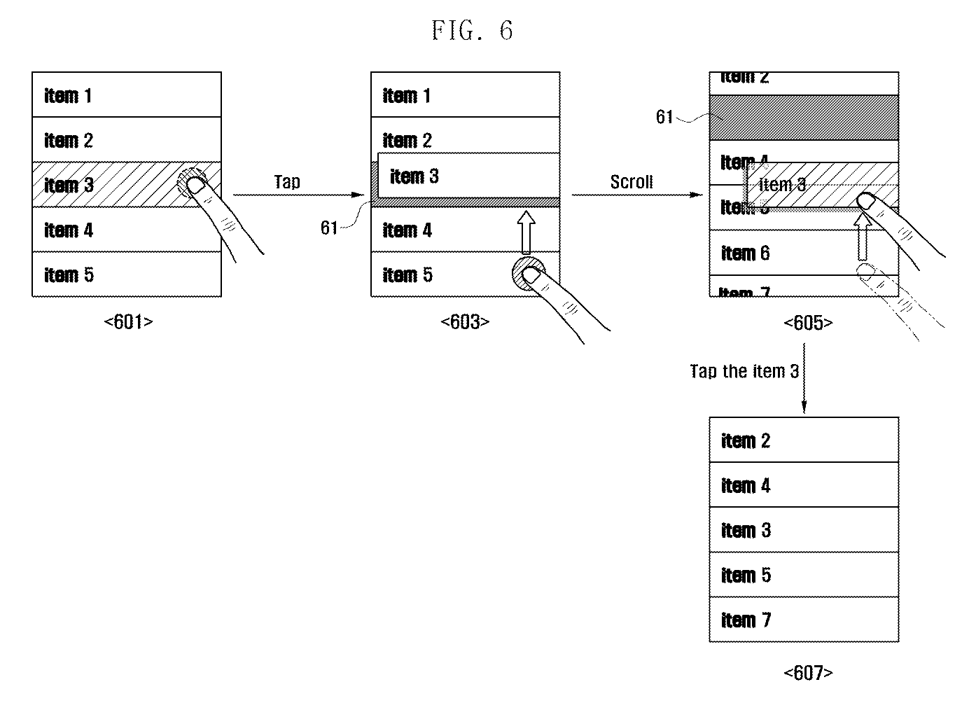

FIG. 6 is a view illustrating screens describing a list-editing method according to an exemplary embodiment of the present invention.

Referring to FIGS. 2 and 6, the mobile device 100 displays a list screen comprised of five item regions according to a user's selected menu or function. For example, the mobile device 100 may display fives items, for example, Items 1, 2, 3, 4 and 5, on screen 601. The user may select one of the items, for example, Item 3, by the directional keys or the confirmation key of the input unit or by a touch event created when he/she taps the display region of Item 3 on the list screen 601.

If Item 3 is selected on the list screen 601, the mobile device 100 may display Item 3 in such a way that Item 3 seems to be hovering, as illustrated on the list screen 603. Therefore, the display region of Item 3 may be partly superimposed with that of Item 2, and the placement displaying Item 3 is floated and aside, above the placements on which the other items are arranged, at a certain height, so that the background 61 in which Item 3 has been arranged is partly exposed. That is, Item 3 is displayed on a placement that is separated from the placements of the other items, and fixed thereon. Item 3 may be displayed translucently or transparently on the placement. Meanwhile, the user may create a scroll event as illustrated on the list screen 603. That is, the user touches one side of Item 5 and moves his/her finger toward the top without losing contact on the touch screen 140.

While the user continues to create a scroll event, the other items except for Item 3 are moved according to the scroll event. If the user moves Item 5 to a placement under Item 3, the placement of Item 4 and the placement of Item 5 will arrange themselves below Item 3, as illustrated in the list screen 605. In addition, the background 61, created when Item 3 is removed from the placement where non-selected items are arranged, is also moved to the top of the list screen 605, according to the scroll up event, together with the non-selected items.

If the user releases his/her finger from the list screen or taps Item 3 again after releasing his/her finger, the mobile device 100 displays the list screen 607 so that Item 3 is located between Item 4 and Item 5. The mobile device 100 removes the background 61 from the list screen 605 and then arranges Item 2 at the upper side of Item 4, according to the number of items set to be displayed on the list screen.

As described above, the list-editing method according to an exemplary embodiment of the present invention may move at least one item, selected by a user, to a placement that differs from another placement displaying other items and may fix it thereon. If the user's selected item is located and superimposed on the boundary portion between other items according to a scroll event, it can be inserted into the items so that the order of items are altered. During this process, the selected item is displayed translucently or transparently, so that the user may easily recognize information regarding the scrolled items and the fixed items.

Although an exemplary embodiment of the present invention has been explained in such a way that the user touches and moves Item 3 over the list screen so that Item 3 may be arranged and superimposed on the boundary portion between Items 4 and 5 and then releases his/her finger therefrom, it may be modified in such a way that Item 3 is located and superimposed on the boundary portion between Item 2 and the background 61. In this case, the mobile device 100 arranges Item 3 in the initially arranged order of items.

A screen interface for editing a list of items has been described above. A configuration of the mobile device 100 that is adapted to the list-editing method and supports the screen interface will be described below.

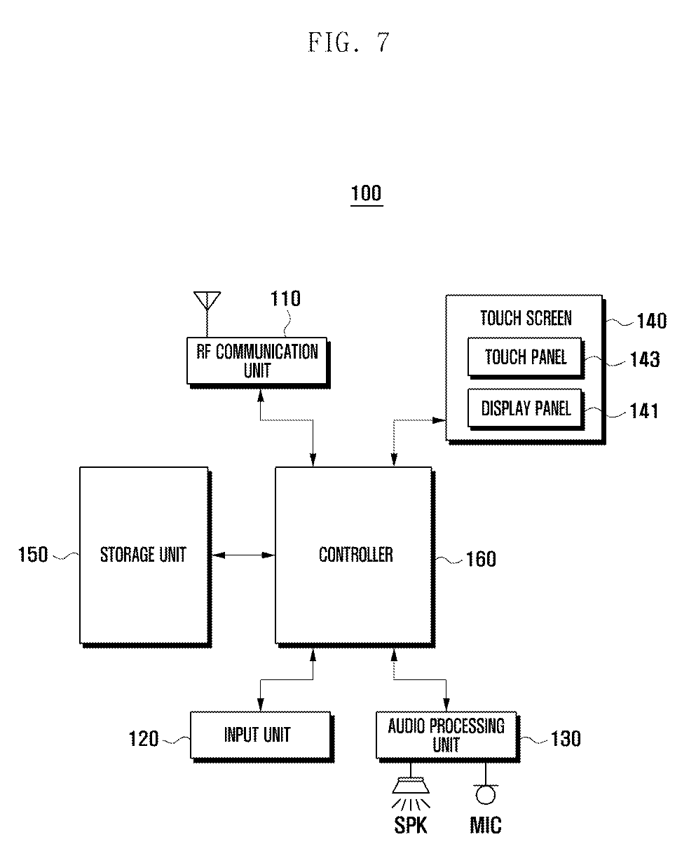

FIG. 7 is a schematic block diagram illustrating a mobile device adapted to a list-editing method, according to an exemplary embodiment of the present invention.

Referring to FIG. 7, the mobile device 100 includes a Radio Frequency (RF) communication unit 110, an input unit 120, an audio processing unit 130, a touch screen 140, a storage unit 150, and a controller 160. The RF communication unit 110 may be omitted if the mobile device 100 does not support a communication function. The input unit 120 may also be omitted if the mobile device 100 is designed in such a way that the touch screen 140 serves to perform an input function, i.e., generates input signals.

The mobile device 100 activates an application program to execute user functions, according to a user's request. The user functions include a function for displaying a list of items. The mobile device 100 may activate the application program to display at least one item on the list screen. If the mobile device 100 is operated in an edit mode, the mobile device 100 fixes a user's selected item at one side of the screen and moves the remaining items except for the user's selected item in a certain direction according to a scroll event. Therefore, the mobile device 100 may quickly alter the order of the user's selected item in the list. The following description describes elements of the mobile device 100 and their functions.

The RF communication unit 110 establishes a channel for voice communication and a communication channel for transmitting data, such as video data, and the like, under the control of the controller 160. That is, the RF communication unit 110 establishes a voice call channel, a data communication channel, and a video call channel with an external mobile communication system. The RF communication unit 110 includes an RF transmitter for up-converting the frequency of signals to be transmitted and amplifying the signals and an RF receiver for low-noise amplifying received RF signals and down-converting the frequency of the received RF signals. In an exemplary implementation, the RF communication unit 110 may be activated according to a touch event that occurred on a touch panel 143 of the touch screen 140. The mobile device 100 may collect call log information generated when the RF communication unit 110 is operated. The call log information may be, as an item, provided to the list screen. That is, the call log information may be configured as items in a list on the list screen.

The input unit 120 includes many input keys and function keys that receive numerical or letter information and set a variety of functions to the mobile device 100. The function keys include direction keys, side keys, shortcut keys, and the like, which are set to perform specific functions. The input unit 120 creates key signals related to a user's settings and to the function control of the mobile device and outputs them to the controller 160. The input unit 120 may be implemented with a QWERTY keypad, a 3×4 keypad, a 4×3 keypad, a direction keypad, and the like. The input unit 120 may be omitted if the mobile device 100 supports a full screen with the touch screen 140. In this case, the touch screen 140 also serves as the input unit 120. In an exemplary implementation, the input unit 120 may create a variety of input signals and output them to the controller 160. For example, the input signals may be a signal for activating a list screen corresponding to a particular menu or function according to a user's operation, a first input signal for selecting a particular item on the list screen, a second input signal for scrolling items on the list screen in a certain direction, and a signal for releasing the scrolling operation. If a function for creating a scroll input signal is allocated to a particular button, the input signal for releasing the scrolling operation may be created when a pressed state of a particular button is released.

The audio processing unit 130 includes a Speaker SPK for reproducing audio data transmitted during the call and a Microphone MIC for receiving a user's voice or audio signals during the call. In an exemplary implementation, the audio processing unit 130 may output corresponding audio signals when the screen states are altered on the list screen. For example, the alteration of the screen state may be a selection of an item on the list screen, an occurrence of a scroll event, an alteration of the order of a selected item, and the like.

The touch screen 140 includes a display panel 141 and a touch panel 143, where the touch panel 143 is installed to the front of the display panel 141. The size of the touch screen 140 is determined based on the size of the touch panel 143.

The display panel 141 displays menus of the mobile device 100, and information input by a user or information provided to the user. That is, the display panel 141 provides various types of screens according to the operation of the mobile device 100, such as an idle screen, menu screens, a message writing screen, a call screen, and the like. In an exemplary implementation, the display panel 141 displays at least one item on the list screen. When a list screen is displayed according to an additional input signal, the display panel 141 may display a screen on which an indication is requested to select an item, a screen on which the selected item is fixed, a screen on which the other items is moved according to a scroll signal in a state where the selected items is fixed, a screen on which the order of the fixed item is altered in the list while the other items are moved, and the like. The display unit 141 may be implemented with a Liquid Crystal Display (LCD), an Organic Light Emitting Diode (OLED), and the like.

The touch panel 143 is installed to the mobile device 100 so that it covers the display panel 141. The touch panel 143 creates a touch event when an object contacts it or approaches close to it, and outputs a signal corresponding to the touch event to the controller 160. The touch panel 143 includes a plurality of sensors arrayed in a matrix. The touch panel 143 detects a touch event and outputs information regarding a location where the touch event occurs and information regarding the type of touch event to the controller 160. For example, the type of touch event may be a touch down event that occurs when an object contacts the touch panel, a touch up or release event that occurs when the object is removed from the touch panel, a scroll event or a touch move or drag event that occurs when a touched object is moved on the touch panel in a certain direction without losing contact, a flick event that occurs when a touched object brushes the touch panel in a certain direction at an acceleration, and the like.

The storage unit 150 stores application programs for executing functions according to the present invention. If the mobile device 100 is equipped with a touch screen 140, the storage unit 150 stores a key map and a menu map to operate the touch screen 140. The key map and menu map may be implemented with various modes. For example, the key map may be a keyboard map, a 3×4 key map, a QWERTY key map, and the like. In addition, the menu map may be a menu map for controlling an application program that is currently activated, a menu map containing a variety of menus provided by the mobile device 100, and the like. More particularly, the storage unit 150 may store an application program for displaying at least one item on the list screen. If an order of a particular item is altered in the list of items on the list screen, the storage unit 150 may store the altered order of the list of items, under the control of the controller 160 that is operated according to a user's setting or a preset schedule. The storage unit 150 may output the altered order of the list of items to the controller 160 when the application program is activated. The controller 160 may display the altered order of the list of items on the list screen.

The controller 160 supplies electric power to elements in the mobile device 100 and initializes them. Thereafter, the controller 160 controls a signal flow in order to provide a list-editing function. If the controller 160 receives an input signal for selecting a particular item from at least one of the input unit 120 and the touch screen 140 while at least one item is displayed in a list on the list screen, the controller 160 fixes the item corresponding to the received input signal at one side of the display panel 141. Thereafter, the controller 160 moves the remaining items except for the fixed item according to a scroll signal output from at least one of the input unit 120 and the touch screen 140. If movement of the items is terminated and the scroll signal is not generated, the fixed item is arranged between the moved items. During this process, the controller 160 moves the fixed item, by a certain distance, according to the scroll event, and then fixes the fixed item at one side of the display panel 141. In addition, the controller 160 may also arrange the fixed item on a placement that differs from the placements displaying the other items, so that the fixed item may be moved, together with the other items, while being superimposed on the other items, when the other items are moved. During this process, the controller 160 may display the fixed item translucently or transparently. If the fixed item is superimposed on the non-selected items and then a particular input signal, for example, a signal for releasing a scroll event, is created, the controller 160 may insert the fixed item into the non-selected items portions of which are superimposed within the fixed item.

Although an exemplary embodiment of the present invention has been described based on a case where one of the items is selected, it should be understood that the present invention is not limited thereto. For example, the exemplary embodiments of the present invention may be modified in such a way that two or more items may be selected from a list of a plurality of items, according to a user's settings, and then fixed at one side of the list screen. The non-selected items may be moved according to a scroll event that occurs after the two or more items have been selected. More particularly, the selected items may be moved by a certain distance and then fixed to one side of the list screen, according to a scroll event that occurs after the items have been selected. For example, if Items 2 and 5 are selected on a list screen displaying Items 1 to 7 in a list (not illustrated), Items 2 and 5 may be moved, together with non-selected items, on the list screen, toward the top, according to a scroll up event, for example, which occurs after Items 2 and 5 have been selected. If Item 2 reaches the highest position of the list screen, the mobile device 100 fixes it thereat. Thereafter, the mobile device 100 may move Items 3 and 4 toward the top and may then remove them from the list screen, according to a scroll event that continuously occurs. In addition, if Item 5 is arranged near the bottom of Item 2 as the scroll event continues to occur, the mobile device 100 may fix Item 5 thereat. As such, the mobile device 100 may fix Item 2 and Item 5, in order, from the highest position of the list screen, and may move non-selected items according to the scroll event. Alternatively, the mobile device 100 may move Items 2 and 5 to the lowest position of the list screen according to the scroll down event and then fix them thereat. In addition, if Item 2 is moved to and fixed at the highest position of the list screen according to a scroll up event and then a scroll down event occurs, the mobile device 100 may move Item 5 to the lowest position of the list screen and may fix it thereat. In this case, Item 2 is arranged at the highest position of the list screen and Item 5 is arranged at the lowest position.

The list-editing method and the mobile device adapted to the method, according to an exemplary embodiment of the present invention, may allow a user to perform item selection even after a scroll event has occurred. For example, if a list screen is comprised of 10 item display regions and is displaying 10 items, Items 1 to 10, once, and a user selects Items 2 and 4 (not illustrated), the mobile device 100 may fix the items at their current locations, respectively, or at one side of the list screen. If a scroll event occurs, the mobile device 100 moves the remaining items, except for Items 2 and 4, in a certain direction according to the scroll event. For example, Item 5 is arranged at the highest position of the list screen and then Items 2, 6, 4, 7, 8, 9, and 10 are arranged in order therefrom. In addition, if Items 1 and 3 are removed from the list screen, Items 11 and 12 are newly displayed following Item 10. If the user selects a particular item, for example, Item 11, the mobile device 100 may fix Item 11 at its current location or at one side of the list screen. Therefore, there are three fixed items, Items 2, 4, and 11, on the current list screen.

As described above, although exemplary embodiments of the present invention provide the scroll signals based on a scroll up or scroll down event to arrange the items in a list, it should be understood that the present invention is not limited to the embodiment. For example, if the items are arranged in a grid, the scroll signal may further include a scroll right signal, a scroll left signal, or a scroll diagonal signal.

As described above, the mobile device 100 may fix one item selected from the items in a list on a list screen and move the remaining items according to an input signal, thereby changing the order of the selected item in the list.

As described above, the list-editing method according to an exemplary embodiment of the present invention may easily change the order of items in a list. The mobile device adapted to the method may also allow users to easily change the order of items in a list.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A list-editing method, the method comprising:
displaying a plurality of items in a list on a screen;
selecting at least one of the plurality of items according to an input signal;
fixing at least one selected item at one side of the screen; and
moving at least one non-selected item on the screen, according to a scroll signal.

2. The method of claim 1, wherein the fixing of the at least one selected item at the one side of the screen comprises:
fixing at least one selected item at least one of a highest position and a lowest position on the screen; and
fixing at least one selected item at a location in the list at a time point when at least one of the items in the list was selected.

3. The method of claim 2, further comprising:
at least one of translucently and transparently displaying at least one selected item at a placement that differs from a placement on which at least one non-selected item is displayed.

4. The method of claim 3, further comprising:
at least one of displaying at least one non-selected item to be superimposed with at least one selected item that is at least one of translucently and transparently displayed and inserting, if the scroll signal is not input, at least one selected item between non-selected items whose portions are superimposed with at least one selected item, so that the order of items is altered in the list.

5. The method of claim 1, wherein the fixing of the at least one selected item at the one side of the screen comprises:
arranging, if the plurality of items are selected in a list screen, the selected items from a highest position of the list screen, in an order, according to the direction of the scroll signal, and fixing the selected items thereat;
arranging, if the plurality of items are selected in the list screen, the selected items from a lowest position of the list screen, in an order, according to the direction of the scroll signal, and fixing them thereat; and
moving, if the plurality of items are selected, the selected items on the list screen according to the direction of the scroll signal, and fixing, if the selected items are located at least one of the highest position and the lowest position of the list screen, the selected items at the highest or lowest position of the list screen.

6. The method of claim 1, wherein the moving of the at least one non-selected item on the screen comprises moving at least one non-selected item on the screen so that a display region of at least one non-selected item is not superimposed on a display region of the at least one selected item.

7. The method of claim 1, further comprising:
displaying, if the list of items is displayed, a key map for executing a list-edit mode;
creating an input signal according to a selection of the key map; and
entering the list-edit mode according to the selection of the key map.

8. The method of claim 1, further comprising:
altering the order of the selected item in the list of items when the non-selected items are moved in a state where the selected item is fixed at one side of a list screen; and
storing the altered order of items in the list.

9. A mobile device supporting list-edit, the device comprising:
a display panel for displaying a plurality of items in a list;
at least one of an input unit and a touch screen for creating an input signal for selecting at least one of the plurality of items in the list and a scroll signal for moving at least one non-selected item on the display panel; and
a controller for fixing at least one selected item at one side of a screen, for moving at least one non-selected item on the screen according to a scroll signal, and for altering an order of at least one non-selected item in the list.

10. The device of claim 9, further comprising:
a storage unit for storing the altered order of the items in the list.

11. The device of claim 9, wherein the controller fixes at least one selected item at least one of a highest position and a lowest position of at least one of the list screen and a region in the list at a time point when at least one item was selected.

12. The device of claim 9, wherein the display panel displays the list and the items so that a placement displaying at least one non-selected item is distinguished from a placement displaying at least one selected item.

13. The device of claim 12, wherein the display panel displays at least one selected item at least one of translucently and transparently.

14. The device of claim 13, wherein, if at least one non-selected item is at least one of moved and moved and then stopped according to a scroll signal, the display panel displays part of the non-selected item so that the part of the non-selected item is superimposed with at least one selected item that is being displayed at least one of translucently and transparently.

15. The device of claim 14, wherein, if the scroll signal is not input in a state where the part of the non-selected item is superimposed with at least one selected item, the controller inserts at least one selected item into non-selected item portions of which are superimposed with at least one selected item and alters the order of items in the list.

16. The device of claim 9, wherein the display panel displays items so that the display region of at least one selected item is not superimposed with the display region of at least one non-selected item that is at least one of moved and moved and then stopped according to a scroll signal.

17. The device of claim 9, wherein the display panel displays a key map for executing a list-edit mode.

18. The device of claim 17, wherein the input signal is created according to a selection of the key map.

19. The device of claim 18, wherein the list-edit mode is entered according to the selection of the key map.

20. The device of claim 9, wherein the controller alters the order of the selected item in the list of items when the non-selected items are moved in a state where the selected item is fixed at one side of a list screen.
